(19) United States
(12) Patent Application Publication
(10) Pub. No.: US 2011/0024355 A1
(43) Pub. Date: Feb. 3, 2011

(54) ANTIMICROBIAL MEMBRANES

(75) Inventors: Jaleh Mansouri, Rosebery (AU); Dirk Simon, Lorrach-Brombach (DE); Arun Prasath Ramaswamy, Coimbatore (IN); Vicki Chen, Earlwood (AU); Thomas Weiss, Ilversheim (DE)

Correspondence Address: BASF Corporation;Patent Department, 500 White Plains Road, P.O. Box 2005, Tarrytown, NY, 10591, US

(73) Assignee: POLYMERS CRC LTD., Notting Hill (AU)

(21) Appl. No.: 12/679,934

(22) PCT Filed: Aug. 29, 2008
(86) PCT No.: PCT/EP2008/063000

§ 371 Date: Oct. 15, 2010

(30) Foreign Application Priority Data
Oct. 10, 2007 (EP) 07118215.8

(51) Int. Cl. B01D 67/00; A01N 59/16; A01N 25/00; A01P 1/00; A01P 13/00; B01D 69/02

(52) U.S. Cl. 210/650; 424/618; 424/400; 210/500.21; 210/501

(57) ABSTRACT

The present invention discloses the preparation of antimicrobial membranes by inclusion of low leaching, control release silver-based antimicrobial additives as described in claim 1 into the polymer matrix and forming this into a semipermeable membrane. The antimicrobial agents protect the membrane system against bacterial and/or algal decay and assist in maintaining a high efficiency of the membrane filtration process.

The present invention relates generally to the use of certain non-leaching antimicrobials in water treatment or gas separation membranes, more particularly to the use of silver-based antimicrobials in a water purification system which may be exposed to bacterial contamination.

It is known that polymers and plastics, e.g. when used as coatings on substrates can suffer from bacterial or algal decay if routinely exposed to water, dampness or moisture. Biofilms of communities of bacteria and algae can settle on the surfaces of these substrates and increase the speed of decay and/or loss of efficacy. The use of certain organic antimicrobials in air filter systems has already been proposed; US-A-2003-038074 teaches incorporation of a non-metallic antimicrobial agent such as 2,4,4′-trichloro-2′-hydroxy diphenyl ether into semi-permeable membranes. Also U.S. Pat. No. 5,102,547 discloses a semi-permeable polymeric membrane in which unmodified metals such as silver, copper and antimony are incorporated into a polymer. U.S. Pat. No. 6,652,751 teaches attachment of bacteriostatic metal ions to a surface of a preformed polymeric membrane by static adsorption/absorption or mixing the metal salt into polymeric solution and casting into a bath containing a reducing agent.

Bacteria contained in the influent water are accumulated by the membranes and consequently accumulate on their surfaces. The rapid growth of bacteria results in fouling of the membrane which reduces the flow of water through the membrane and can adversely affect the filtering properties of the membrane.

As a result of bacterial growth on the membrane, a gelatinous biofilm is formed on the upstream side of membrane that is very difficult to remove except through the use of aggressive cleaning. This can compromise membrane lifetime as well as incur significant costs. There is a need for membranes with long-term antimicrobial activities.

Non-soluble antimicrobials embedded in the membrane provide a membrane surface which is resistant to microbial colonization and adhesion, and provide more easily removed foulant layers. Another application would be in water reuse applications (RO, NF, MF etc) where microbial growth occurs on the membrane, even with relatively “clean” water, and causes fouling.

The prevention of biofilm-formation on membrane materials used in gas separation or water processing for preparing e.g. drinking water, process water or cooling water, or improve their quality is one of the principal embodiment of this invention. The membranes prepared are particularly useful in desalination, membrane bioreactors and other aqueous purification processes. The membranes may be semi-permeable membranes, as commonly used in conventional filtration processes, or dense membranes as used, for example, in reverse osmosis processes.

In the present invention, a non-leaching antimicrobial substance is added to the polymer composition of the membrane. Surprisingly, this measure may lead to a reduction of biofilm growth by at least 20%, compared to the same membrane not containing the present antimicrobial (as characterized by a Pseudomonas aeruginosa biofilm growth observed by phenol-sulfuric acid carbohydrate assay). This effect may, other than with conventional agents which tend to leach out, be observed throughout the membrane's lifetime, i.e. 1 year or longer. In many cases, an even higher, and lasting, reduction of biofilm growth by at least one quarter (25%) or even one third (33%) is achieved.

The non-leaching antimicrobial substance used according to the invention generally comprises antimicrobial materials which are substantially insoluble in water, often in the form of particles. The particles usually comprise an inorganic bioactive material, especially an insoluble oligodynamic bioactive material. Preferably, the non-leaching antimicrobial substance is selected from silver-based antimicrobials in the form of elemental silver and/or supported silver such as highly porous microsilver, silver nanoparticles, silver zeolites, silver glass. The non-leaching antimicrobial substance may be added to the polymer composition forming the membrane. A film is formed in which silver-based particles are dispersed, mainly at the surface. Incorporation of the silver may advantageously be effected by addition of the additive particles to the polymeric casting solution. The membrane may be formed after immersion of said solution in a coagulation bath (mainly water). The invention thus further relates to antimicrobial polymeric membranes and the process for the preparation thereof.

The present membranes are mainly useful for the filtration of aqueous liquids or aqueous dispersions, e.g. selected from liquid food, beverages, pharmaceuticals and pre-products thereof. They may further be used for:

gas separation,
the separation of bio-molecules or bio-particles, e.g. blood-platelets or bio-polymers of high molecular weight such as proteins, from aqueous liquids or dispersions in biotechnology or medicine,
the filtration of water used in power generation,
the purification and/or decontamination of water for industrial processes, chemical processes, metal treatment, semiconductor processing, pulp and paper processing, and especially of drinking water and/or waste water.

The membranes of the invention are capable of reducing biofilm growth by a Pseudomonas aeruginosa by at least 20%, as observed by phenol-sulfuric acid carbohydrate assay, compared to the same membrane not containing the substantially water insoluble oligodynamic bioactive material.

These specific types of additives provide membranes with particular mechanisms for well-dispersed, slow release of, preferably silver, active substance for durable enhancement of antimicrobial properties of the membrane. The membranes include a polymeric material and a controlled release, slow-leaching antimicrobial agent, from the above mentioned agents, that is incorporated into and either homogeneously distributed throughout the polymeric material or dispersed in the polymeric material near its surface. Polymeric membranes may be prepared from organic polymers, e.g. as commonly listed in WO04/106311 page 48, bottom paragraph, until page 54 (item 29). Preferred polymers are cellulose acetates, polyacrylonitriles, polyamides, polyolefins, polyesters, polysulfones, polyethersulfones, bisphenols, polyether ketones, sulfonated polyether ketones, polyamide sulfones, polyvinylidene fluorides, polyvinylchlorides and other chlorinated polyethylenes, polystyrenes and polytetrafluorethylenes or mixtures thereof. More preferred membrane polymers are polyolefines, polyester, polyvinylidenefluoride, aromatic polysulfones, aromatic polyphenylene-sulfones, aromatic polyethersulfones, polyamide, and their copolymers, or the group consisting of polyolefins, polyester, polyvinylidenefluoride, polysulfone, polyethersulfone, polyamide, and their copolymers, as well as other polymers commonly used in fabrication of membranes and known as state of the art.

In closed water systems (water purification, desalination) using e.g. plastic parts such as pipes, filters, valves or tanks can be subject to bacterial or algal colonization and biofilm formation, leading to serious damages of filter efficacy, such as membrane permeability (flow rate), and followed by deterioration of the materials and contamination of the circuit liquids.

Other problems with said surfaces can derive from algal or bacterial biofilm formation resulting in an undesired change in their hydrodynamic properties and affecting e.g. the flow-rate in pipes, or also the trouble-free use of boats, marine or other limnological applications.

The present silver additives are selected from the group consisting of silver zeolites in combination with a zinc compound, silver zinc zeolithes, silver glass, and elemental (metallic) silver of high specific surface area, preferably of 3 m²/g or more, such as silver nanoparticles or porous microsilver. These silver additives bring about the advantage of being non-leaching in the membrane material, i.e. retaining the active silver over long periods of operation such as months or years, while providing sufficient amounts of active silver ions in order to maintain the antimicrobial (oligodynamic) effect. The present silver additives are able to provide these active silver ions with common membrane polymers, i.e. the presence of charged or chargeable groups or molecules in the membrane is not necessary. The invention thus includes a membrane or membrane system comprising a semi-permeable or dense membrane, which membrane contains, as a dispersed component of at least a portion of its interior and/or its surface, at least one non-leaching bioactive particle material which is selected from the group consisting of silver glass, silver zeolite in combination with zinc, and elemental silver of high specific surface area, where the membrane material is essentially free of charged or chargeable groups or molecules. A further embodiment is the use of said bioactive particle material as an antimicrobial in a membrane for water-treatment or gas-separation processes, where the membrane material is essentially free of charged or chargeable groups or molecules. A further embodiment is a method of maintaining the efficiency of a membrane gas or especially water filtration system, where the membrane material is essentially free of charged or chargeable groups or molecules, which method comprises protecting said system against bacterial and/or algal decay by incorporation of silver releasing particles selected from the group consisting of silver zeolites combined with a zinc compound, silver zinc zeolithes, silver glass, and elemental silver of high specific surface area, into the membrane material.

Zeolite supported silver and/or zinc (silver zeolite containing zinc) is disclosed in U.S. Pat. Nos. 4,775,585; 4,911,898; 4,911,899. Zeolite supported silver is also taught in U.S. Pat. No. 6,585,989.

Glass supported silver (silver glass), with or without zinc, is disclosed for example in published U.S. app. No. 2005/0233888. Use of silver glass is a preferred embodiment of the present invention.

Antibacterial plastic products containing metallic silver fine particles are taught for example in published U.S. app. No. 2006/0134313, or U.S. Pat. Nos. 6,720,006; 6,822,034.

U.S. Pat. No. 6,984,392 teaches antimicrobial porous microsilver.

A zeolite is generally aluminosilicate having a three dimensionally grown skeleton structure and is generally represented by xM_{2/n}O.Al₂O₃.ySiO₂.zH₂O, written with Al₂O₃ as a basis, wherein M represents an ion-exchangeable metal ion, which is usually the ion of a monovalent or divalent metal; n corresponds to the valence of the metal; x is a coefficient of the metal oxide; y is a coefficient of silica; and z is the number of water of crystallization. The zeolites of the present invention have a specific surface area of at least 150 m²/g. The present zeolites support antimicrobial silver, that is silver is retained mainly at the ion-exchangeable sites of the zeolite.

The silver supported on a zeolite may be a surface-modified silver supported zeolite, or silver zinc zeolite, according to U.S. Pat. No. 6,071,542.

In the zeolite material useful in the present invention, the silver or zinc ions may be located on ion exchange sites or within the crystal frame or on both types of sites.

The silver supported on a zeolite usually makes up about 0.1 to about 5% by weight of the zeolite material.

The silver supported on glass may also include zinc, that is may be silver glass or silver zinc glass. Glass supported silver is taught for example in published U.S. application 2005/0233888, the disclosure of which is hereby incorporated by reference. The glass may be, for example, a magnesium-sodium-phosphate-borate glass additionally containing silver and/or zinc, or an aluminum-phosphate-borate glass additionally containing silver and/or zinc.

The silver supported on glass usually makes up about 0.1 to about 5% by weight of the glass material.

As noted above, silver releasing particles on support comprising (usually ionic) silver are used in combination with zinc (in case of the zeolite particles) or may be used in combination with zinc (in case of the silver-glass particles). Zinc in these additives also is generally in the form of ions. If containing silver and zinc, these materials may contain both types of metals within the same type of particle, or may be used as a mixture of one or more class(es) of particles containing silver, and one or more other class(es) of particles containing zinc:

For example, the silver zeolite containing zinc may be selected from silver zinc zeolite, silver zeolite mixed with zinc zeolite, silver zeolite mixed with zinc glass, silver zeolite mixed with another zinc salt such as zinc oxide, or combinations of such materials such as silver zinc zeolite mixed with zinc oxide. The weight ratio zeolite:zinc salt in such combinations often is from the range 1:1 to 1:10.

For example, any silver glass containing zinc may be selected from silver zinc glass, silver glass mixed with zinc glass, silver glass mixed with zinc zeolite, silver glass mixed with another zinc compound, or combinations of such materials. Silver glass is preferably not combined with zinc oxide, and a preferred type of silver zinc glass is essentially free of zinc oxide, as in the case of phosphate and/or borate glasses. Besides silver, other cations in these glasses often are selected from sodium, magnesium, aluminum, and zinc in case of silver zinc glass. The weight ratio Ag:Zn in a preferred silver zinc glass ranges from about 1:30 to about 1:60.

In cases where supported zinc is used (e.g. zinc supported on zeolite or glass), zinc usually makes up about 0.1 to about 5% by weight of this class of material.

Where the silver containing particle (silver zeolite, silver zinc zeolite, silver glass, elemental silver) is used in combination with another material containing zinc, the weight ratio silver:zinc usually is from the range 10:1 to about 1:500.

Use of silver zeolithe in combination with a zinc compound, and especially use of silver zinc zeolithe, is a preferred embodiment of the present invention.

Advantageous additive particle compositions include, for example a composition containing a silver releasing particle comprising, on 100 parts by weight of the additive particles,

5 to 50, especially 10 to 40, parts by weight of a silver zeolite or silver zinc zeolite; and 50 to 95, especially 60 to 90, parts by weight of a zinc compound which is substantially water insoluble such as zinc oxide or zinc zeolite;
or
50 to 100, especially 100, parts by weight of a silver glass or silver zinc glass; and 0 to 50, especially 0, parts by weight of a zinc compound which is substantially water insoluble such as zinc oxide or zinc zeolite.

Further materials useful in combination with the silver containing particle include, besides the supported zinc and zinc salts noted above, phosphates such as calcium phosphates, hydrotalcites, or filler materials as listed further below (item 12 of the list of further additives). The weight ratio of these further materials to the silver and/or zinc containing particles often is from the range 5:95 to 95:5.

The elemental silver may be micro scaled or may be nano scaled. Nano scaled antibacterial silver is disclosed for example in U.S. Pat. No. 6,822,034, the relevant disclosure of which is hereby incorporated by reference. Nanosilver usually has mean particle sizes from the range 5 to 100 nm; minor amounts of the silver in this material may be in the form of silver oxide. The nano scaled antibacterial silver is preferably obtained by physical means (e.g. physical vapour deposition processes) and not by reduction of silver salts (such as solutions e.g. of silver nitrate). Use of elemental nano scaled silver is a preferred embodiment of the present invention. Metallic silver is also taught in U.S. Pat. No. 6,984,392, the disclosure of which is also incorporated by reference. The porous microsilver to be used according to the invention preferably comprises primary particles of average particle size from about 10 nm to about 100 nm, which form aggregates of average particle size ranging from about 1 to about 20 micrometer, preferably 10-20 micrometer. These aggregates may have a porosity of up to 95%, their porosity usually is more than 50%, expediently between 70 and 95%. Use of porous microsilver is a preferred embodiment of the present invention.

Elemental silver particles useful in the present invention generally do not contain significant amounts of zinc, i.e. the percentage of non-silver metal atoms therein (including zinc) usually is below 1 atom-%, especially below 0.1 atom-%.

The amount of elemental silver employed is for example from about 0.01 to about 5.0 weight percent, based on the weight of the polymer. For instance, the amount of elemental silver employed is from about 0.01 to about 2.0 weight percent or from about 0.01 to about 1.0 weight percent, based on the weight of the polymer.

The amount of supported silver employed is for example from about 0.001 to about 0.2 weight percent, based on the weight of the polymer. For instance, the amount of supported silver employed is from about 0.01 to about 0.2 weight percent or from about 0.05 to about 0.2 weight percent, based on the weight of the polymer. These weight levels are based on the silver.

In case that a mixture of elemental and supported silver is used, the elemental silver/supported silver weight/weight ratio (based on silver) is for example from about 1:10 to about 1:100.

Further additives such as antimicrobials may also be present in the polymer membranes, for instance di- or trihalogeno-hydroxydiphenylethers such as Diclosan or Triclosan, 3,5-dimethyl-tetrahydro-1,3,5-2H-thiodiazin-2-thione, bis-tributyltinoxide, 4.5-dichlor-2-n-octyl-4-isothiazolin-3-one, N-butyl-benzisothiazoline, 10.10′-oxybisphenoxyarsine, zinc-2-pyridinthiol-1-oxide, 2-methylthio-4-cyclopropylamino-6-(α,β-dimethylpropylaminoys-triazine, 2-methylthio-4-cyclopropylamino-6-tert-butylamino-s-triazine, 2-methylthio-4-ethylamino-6-(α,β-dimethylpropylamino)-s-triazine, 2,4,4′-trichloro-2′-hydroxydiphenyl ether, IPBC, carbendazim or thiabendazole.

Further additives useful may be selected from the materials listed below, or mixtures thereof:

### 1. Antioxidants:

1.1. Alkylated monophenols, for example 2,6-di-tert-butyl-4-methylphenol,
1.2. Alkylthiomethylphenols, for example 2,4-dioctylthiomethyl-6-tert-butylphenol,
1.3. Hydroquinones and alkylated hydroquinones, for example 2,6-di-tert-butyl-4-methoxyphenol, 2,5-di-tert-butylhydroquinone,
1.4. Tocopherols, for example α-tocopherol,
1.5. Hydroxylated thiodiphenyl ethers, for example 2, 2′-thiobis(6-tert-butyl-4-methylphenol),
1.6. Alkylidenebisphenols, for example 2, 2′-methylenebis(6-tert-butyl-4-methylphenol),
1.7. O-, N- and S-benzyl compounds, for example 3, 5,3′,5′-tetra-tert-butyl-4,4′-dihydroxydi-benzyl ether,
1.8. Hydroxybenzylated malonates, for example dioctadecyl-2,2-bis(3,5-di-tert-butyl-2-hydroxybenzyl)malonate,
1.9. Aromatic hydroxybenzyl compounds, for example 1,3,5-tris(3,5-di-tert-butyl-4-hydroxybenzyl)-2,4,6-trimethylbenzene,
1.10. Triazine compounds, for example 2,4-bis(octylmercapto)-6-(3,5-di-tert-butyl-4-hydroxyanilino)-1,3,5-triazine,
1.11. Benzylphosphonates, for example dimethyl-2,5-di-tert-butyl-4-hydroxybenzylphosphonate,
1.12. Acylaminophenols, for example 4-hydroxylauranilide,
1.13. Esters of β-(3,5-di-tert-butyl-4-hydroxyphenyl)propionic acid with mono- or polyhydric alcohols, 1.14. Esters of β-(5-tert-butyl-4-hydroxy-3-methylphenyl)propionic acid with mono- or polyhydric alcohols,
1.15. Esters of β-(3,5-dicyclohexyl-4-hydroxyphenyl)propionic acid with mono- or polyhydric alcohols,
1.16. Esters of 3,5-di-tert-butyl-4-hydroxyphenyl acetic acid with mono- or polyhydric alcohols,
1.17. Amides of β-(3,5-di-tert-butyl-4-hydroxyphenyl)propionic acid e.g. N,N¹-bis(3,5-di-tert-butyl-4-hydroxyphenylpropionyl)hexamethylenediamide,
1.18. Ascorbic acid (vitamin C),
1.19. Aminic antioxidants, for example N,N′-di-isopropyl-p-phenylenediamine.
2. UV absorbers and light stabilizers:
2.1. 2-(2′-Hydroxyphenyl)benzotriazoles, for example 2-(2′-hydroxy-5′-methylphenyl)-benzotriazole,
2.2. 2-Hydroxybenzophenones, for example the 4-hydroxy derivatives,
2.3. Esters of substituted and unsubstituted benzoic acids, for example 4-tert-butyl-phenyl salicylate,
2.4. Acrylates, for example ethyl α-cyano-β,β-diphenylacrylate,
2.5. Nickel compounds, for example nickel complexes of 2,2′-thio-bis[4-(1,1,3,3-tetramethyl-butyl)phenol],
2.6. Sterically hindered amines, for example bis(2,2,6,6-tetramethyl-4-piperidyl)sebacate.
2.7. Oxamides, for example 4, 4′-dioctyloxyoxanilide,
2.8. 2-(2-Hydroxyphenyl)-1,3,5-triazines, for example 2,4-bis(2,4-dimethylphenyl)-6(2-hydroxy-4-octyloxyphenyl [or -4-dodecyl/tridecyloxyphenyl])-1,3,5-triazine.
3. Metal deactivators, for example N,N′-diphenyloxamide.
4. Phosphites and phosphonites, for example triphenyl phosphite.
5. Hydroxylamines, for example N,N-dibenzylhydroxylamine.
6. Nitrones, for example, N-benzyl-alpha-phenylnitrone.
7. Thiosynergists, for example dilauryl thiodipropionate.
8. Peroxide scavengers, for example esters of 3-thiodipropionic acid.
10. Basic co-stabilizers, for example melamine, polyamides, polyurethanes, alkali metal salts and alkaline earth metal salts of higher fatty acids, for example calcium stearate, zinc stearate.
11. Nucleating agents, for example inorganic substances, such as talcum, metal oxides.
12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.
13. Other additives, for example plasticisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384.

For more details on stabilizers and additives useful, see also list on pages 55-65 of WO 04/106311, which is hereby incorporated by reference.

The material may further contain hydrophilicity enhancing additives, such as disclosed in WO 02/42530.

For example, the polymeric material may optionally contain from about 0.01 to about 10%, preferably from about 0.025 to about 5%, and especially from about 0.1 to about 3% by weight of one or more such further stabilizers or additives.

In general, each feature of the present invention, such as the methods for using the above additives including silver and/or zinc containing particles, corresponding uses and membrane systems disclosed, is preferably combined with each specific embodiment, such as the above membrane materials, specific embodiments as mentioned above, or further preferences as noted below.

### Preferences:

The suitable antimicrobial additives are preferably selected from silver zeolite and highly porous elemental silver micro- and nano-particles without ionic additives. Silver primary particles of size between 5 and 150 nm might agglomerate, whereas such agglomerates are preferably used. Silver zeolite additive has the advantage that it is active under wet conditions over a long time period as the silver ions, being part of the zeolite structure, have a very slow and controlled leaching rate. This additive is active especially against a broad range of bacteria. Such a material is marketed under the brand name IRGAGUARD by Ciba Specialty Chemicals Inc.

Elemental silver micro- and nano-particles are extremely durable and suited for applications, where the efficacy is expected to last for a very long time. A preferred elemental porous microsilver is available under the name Hygate 4000 from Biogate. Since it contains pure silver, it may be used in a lower absolute silver concentration.

The antimicrobial silver particles may advantageously be used in an amount of about 0.3 to about 10, especially 0.5 to 8 wt % with respect to the total mass of the polymer.

The process of antimicrobial membrane preparation often follows the steps as outlined below:

In step 1, polymers are dissolved in an organic solvent, such as N-methylpyrrolidone, dichloromethane, dimethylformamide (DMF), dimethylacetamide, etc. or a suitable solvent mixture, e.g. mixture of these. Other common solvents are found in the literature. In step 2, silver based additives are added to the fraction of solvent and are well dispersed, e.g. using ultrasonic mixer or any other suitable mixing devices. In Step 3, the additive slurry is dispersed throughout the polymer solution, e.g. using a mechanical stirrer at optimum speed. In Step 4, other additives (mainly organic and/or polymeric such as listed above, e.g. pore formers and/or hydrophilic additives) commonly used in membrane compositions may be added to the mixture of additive and polymer. In Step 5 the resulting solution is cast into a thin film membrane by known methods resulting in a semi permeable or dense membrane with dispersed antimicrobial at least on one side of membrane. Alternatively, in step 5 the resulting solution is metered into a non-solvent of the polymers where the polymers precipitate in a controlled way to form a semipermeable or dense membrane with the dispersed antimicrobial. Further alternatives of membrane preparation are track-etching, stretching, leaching, interfacial polymerization, sintering, sol-gel processes, adding an active membrane layer, grafting, sputter deposition.

The membrane may be used as a stand alone membrane or may be cast on a support to make a composite membrane. Often used are semi-permeable membranes.

In a preferred embodiment the water processing is carried out in a membrane filtration system.

The action of the antimicrobial agents extends to gram-positive and gram-negative bacteria, such as of the strains Escherichia coli, Staphylococcus aureus or Pseudomonas aeruginosa, and others that may be present in aqueous environment, as well as to yeasts, dermatophytes, algae and others.

The membranes, mostly prepared of polymeric organic materials, may be those known for reverse osmosis, ultrafiltration, nanofiltration, gas separation, pervaporation, and/or microfiltration.

They may be cast as a stand alone film or cast on a support film or membrane in the fabrication of composite membranes and may have flat sheet, fine hollow fiber, capillary, spiral wound, tubular, or plate and frame configuration.

Further, they may be either asymmetric or symmetric. Asymmetric membranes have pore sizes on one face of the membrane that are different from the pore size on the other face. Symmetric membranes have pore sizes that are the same on either face.

The treatment of the membrane materials (before the membrane is formed) or membranes (completed structure) with the present antimicrobial comprises e.g. the incorporation into the membrane material or the membrane structure or into the surface (coating) of the membrane. Said incorporation includes e.g. precipitation or moulding (extrusion) processes. The antimicrobials are generally well fixed within the polymeric material, i.e. they are as a rule non-leachable. The antimicrobials are preferably added as such, and not by precipitation of elemental silver from a solution. The antimicrobials are preferably not formed in situ by reduction of a silver salt.

The membrane system usually comprises at least one cast semi-permeable or dense membrane having a polymeric structure and the controlled release/slow leaching antimicrobial agent incorporated into the polymeric material and dispersed throughout said material or, optionally, in a coating layer.

The polymeric material for the membranes may preferably be selected from the group consisting of cellulose acetates, polyacrylonitriles, polyamides, polyesters, aromatic polysulfones, aromatic polyphenylenesulfones, aromatic polyethersulfones, bisphenols, polyether ketones, sulfonated polyether ketones, polyamide sulfones, polyvinylidene fluorides, polyvinylchlorides, chlorinated polyethylene, polystyrenes and polytetrafluorethylenes or mixtures thereof.

Preferred are membranes of cellulose acetates, polyacrylonitriles, polyamide polysulfones, chlorinated polyethylene and polyvinylidene fluorides.

The membrane efficiency (e.g. the performance with regard to filtering properties or flow rates) is generally not detrimentally affected by the incorporated antimicrobials of the invention which prevent bacteria from forming biofilms on their surfaces or breaching the membranes.

The concentration of the antimicrobial agent may be between about 0.01 and 5%, preferably 0.1 to 2.0% by weight, based on the weight of the polymer used in the membrane preparation.

The preparation of the semipermeable or dense membranes comprising the antimicrobial agents is generally known in the art.

Cellulose acetate membranes are cast e.g. from a composite solution (dope solution) containing e.g. a mixture of cellulose di- and -triacetate and the antimicrobial agent in an amount as indicated above on a support (fabric). The solvent used is e.g. a dioxane/acetone mixture wherein also the antimicrobial agent is readily soluble. They may be cast on a support (polyester fabric) and are allowed to precipitate at lower temperatures.

In the preparation of hollow fiber membranes from e.g. polyacrylonitriles polysulfones, polyether sulfones, polyether ketones, polyvinylidene fluorides or sulfonated polyvinylidene fluorides the solvents used are e.g. aprotic solvents such as dimethylformamide, dimethylsulfoxide, dimethylacetamide, N-methylpyrrolidone and mixtures thereof.

The antimicrobial agents are readily dispersable in said solvents or solvent mixtures and will precipitate with the polymer when a non-solvent comes into contact with the dope solution, e.g. by passing the dope solution through a spinneret to form the hollow fiber.

Composite membranes, such as composite polyamide membranes, may be prepared by casting a dope solution of a polysulfone and antimicrobial agent onto a reinforcing fabric (polyester). When coming into contact with water, the polysulfone and the antimicrobial agent precipitate onto the reinforcing fabric and form a film. After drying this polysulfone film (membrane) is then soaked with an organic carboxylic chloride solution followed by aqueous amine solution, so that a polyamide layer is formed on the polysulfone membrane. After drying a composite membrane for reverse osmosis is obtained.

In an alternative embodiment of the present invention the membrane filtration system may be furnished with antimicrobial properties by rinsing the whole system (membranes, pipes, tanks etc.) with a rinsing liquor containing 0.01 to 2.0% of the antimicrobial agent, based on the weight of the liquor. The antimicrobial agents are normally substantive to the polymeric material of the membrane (filtration) system, and by diffusing into the top layer (e.g. coatings) of the polymeric material a long lasting protection against biofilm growth and bacterial and algal decay can be achieved.

The rinsing method is also suitable to reactivate antimicrobial activities of antimicrobially exhausted membrane filtration systems.

Preferably, the rinsing liquor, which is another object of the present invention, is an aqueous formulation containing besides the antimicrobial agent conventional components like surfactants, which may be non-ionic, anionic or zwitter-ionic compounds, sequestering agents, hydrotropes, alkali metal hydroxides (sources of alkalinity), preservative, fillers, dyes, perfumes and others.

The components and their use in rinsing liquors are well known to those skilled in the art.

The antimicrobials are very efficacious in preventing the growth of almost all kinds of bacteria present in water, have slow, controlled leaching, are safe and non-toxic to human and animal skin, and show good bio-degradability and altogether a more favorable ecological profile in the aquatic environment when compared with e.g. trichloro-hydroxydiphenylethers which are also used as antimicrobials.

The following test methods and examples are for illustrative purposes only and are not to be construed to limit the instant invention in any manner whatsoever. Room temperature (r.t.) depicts a temperature in the range 20-25° C.; over night denotes a time period in the range 12-16 hours. Percentages are by weight unless otherwise indicated.

Abbreviations used in the examples or elsewhere:

### BSA Bovine Serum Albumin

### SEM Scanning Electron Microscopy

EDAX Energy-Dispersive X-Ray spectroscopy

### Materials and Methods

Ultra son E6020P (BASF) is dried at 120° C. for 24 h prior to use. Chemicals and additives are used as received.

### EXAMPLE 1

### Preparation of Silver Zeolite-Pes Membranes

Membranes are prepared by typical non-solvent phase inversion method. Polyethersulfone (PES) (14 g) is dissolved in N-dimethylpyrrolidone (NMP) (41 g) at 60° C. for 2 hours. The required amount of silver zeolite (weight percent of additive to polymer: 0.5-5 wt %) is completely dispersed in about 10 g of NMP and is added to the polymer solution and stirred for about 1 hour until a homogenous solution is obtained. Polyethylene glycol-400 (34 g) is added to the mixture above and stirred for 1 hour. After obtaining a homogeneous solution, the casting solutions are left overnight to allow complete release of bubbles. The solution is cast onto a glass plate with a steel Gardner knife at a wet thickness of 200 μm and immersed in a coagulation bath of milli-Q water. The formed membranes are peeled off and subsequently washed with copious amount of water to remove solvents and other organic residues. Membranes are examined by SEM and EDAX analysis. Microstructure of control and modified membrane is consistent with the morphology of one for ultrafiltration membranes. Results showed satisfactory dispersion of additives at both side of membranes.

### EXAMPLE 2

Effect of the antimicrobial additives on membrane general performance is estimated by measuring the water flux and BSA filtration. A dead-end stirred cell with an effective membrane surface area of 15.2 cm² is used to measure water flux and BSA filtration. Stirrer speed is maintained at 400 rpm and a pressure of 80 kPa is derived from a gas cylinder. A digital balance connected to a personal computer is used to monitor the flux by timed permeate collection. Bovine Serum Albumin (67 kDa) is used as model protein. A solution of 0.5 wt % BSA is made up using Milli-Q deionised water.

The experimental protocol involved cutting the membrane piece, inserting it into the membrane module (cell) and running pure water (Milli-Q) flux for 15-30 minutes at 80 kPa pressure. Following the initial water flux, BSA (0.5 wt %) ultrafiltration is estimated at room temperature and at an operating pressure of 80 kPa for at least 1 hour. Concentrations of BSA in permeate are measured using a UV-VIS spectrometer. The solute rejections are calculated from the absorption measurements at λ=280 nm. Table 1 summarises the filtration performance of membranes.

It is found that the performance of blend membranes is very similar to the untreated (control) membrane, thus the additives do not compromise the intrinsic separation performance of the membrane.

TABLE 1
Flux and separation data for membranes

| | Water | BSA | |
|---|---|---|---|
| | flux, | ultrafiltration, | |
| Membrane | l/m²h | l/m²h | Rejection, % |
| Control PES membrane | 220 | 32 | 99 |
| silver zeolite/PES (0.5/100 wt | 195 | 33 | 98 |
| %) | | | |
| silver zeolite/PES (1/100) | 220 | 32 | 98 |
| elemental microsilver/PES | 210 | 34 | 98 |
| (0.5/100 wt %) | | | |
| elemental microsilver/PES | 220 | 38 | 94 |
| (2.5/100 wt %) | | | |

### EXAMPLE 3

### Biofilm Growth

Ultrafiltration antimicrobial blend membranes using polyethersulfone are made in a method similar to that described in Example 1. Biofilms of Pseudomonas aeruginosa are grown on the membranes of 1.27 cm diameter using a batch-flow CDC Biofilm Reactor (BioSurface Technologies) for 48 hr. The amount of formed biofilm is estimated using a standard phenol-sulfuric acid carbohydrate assay. For each sample four specimens are tested. Antimicrobial blended membranes showed less biofilm formation than the control membranes. In particular, the 4 wt % silver zeolite and 1 wt % elemental microsilver blend membranes show significantly lower biofilm growth. Table 2 illustrates some results for different membranes at 48 hr in a bio-reactor.

TABLE 2
Percentage of reduction in biofilm, quantified using carbohydrate
assay at 48 hr (compared with PES control).

| Membranes | Reduction (%) |
|---|---|
| PES-2 wt % silver zeolite | 28 |
| PES-4 wt % silver zeolite | 48 |
| PES-1 wt % elemental microsilver | 39 |

1-4. (canceled)

5. A method of maintaining the efficiency of a membrane gas or especially water filtration system, which comprises protecting said system against bacterial and/or algal decay by incorporation of silver releasing particles selected from the group consisting of silver zeolites combined with a zinc compound, silver zinc zeolithes, silver glass, and elemental silver of high specific surface area, into the membrane material.

6. The method according to claim 5, wherein the membrane is prepared from an organic polymer selected from the group consisting of cellulose acetates, polyacrylonitriles, polyamides, polyolefins, polyesters, polysulfones, polyethersulfones, bisphenols, polyether ketones, sulfonated polyether ketones, polyamide sulfones, polyvinylidene fluorides, polyvinylchlorides, polystyrenes and polytetrafluorethylenes or mixtures thereof and their copolymers.

7. The method according to claim 5, wherein the particles incorporated contain elemental silver or silver and zinc, the latter comprising 100 parts by weight of additive particles:
5 to 50 parts by weight of a silver zeolite or silver zinc zeolite; and
50 to 95 parts by weight of a zinc compound which is substantially water insoluble;
or
50 to 100 parts by weight of a silver glass or silver zinc glass; and
0 to 50 parts by weight of a zinc compound which is substantially water insoluble; the substantially water insoluble zinc compound being selected from zinc oxide and zinc zeolite.

8. The method according to claim 5 wherein the amount of the silver releasing particles comprises 0.3 to 10% by weight, based on the weight of the membrane polymer.

9. The method according to claim 5 wherein the membrane system contains a further antimicrobial selected from form the group consisting of di- and trihalogeno-hydroxydiphenylethers, 3,5-dimethyl-tetrahydro-1,3,5-2H-thiodiazin-2-thione, bis-tributyltinoxide, 4,5-dichloro-2-n-octyl-4-isothiazolin-3-one, N-butyl-benzisothiazoline, 10.10′-oxybisphenoxyarsine, zinc-2-pyridinthiol-1-oxide, 2-methylthio-4-cyclopropylamino-6-(α,β-dimethylpropylamino)-s-triazine, 2-methylthio-4-cyclopropylamino-6-tert-butylamino-s-triazine, 2-methylthio-4-ethylamino-6-(α,β-dimethylpropylamino)-s-triazine, 2,4,4′-trichloro-2′-hydroxydiphenyl ether, IPBC, carbendazim and thiabendazole

10. A membrane system comprising a semi-permeable or dense membrane containing, as a dispersed component of at least a portion of its interior and/or its surface, at least one non-leaching bioactive material, wherein said dispersed non-leaching bioactive material is in the form of particles linked with said membrane substantially without chemical bonding to said membrane,
which membrane is characterized by a Pseudomonas aeruginosa biofilm growth reduced by at least 20%, as observed by phenol-sulfuric acid carbohydrate assay, compared to the same membrane not containing the non-leaching bioactive material.

11. Membrane system according to claim 10, wherein the non-leaching bioactive material is a substantially water insoluble oligodynamic bioactive material selected from the group consisting of silver zeolites combined with a zinc compound, silver zinc zeolithes, silver glass, and elemental silver of high specific surface area.

12. A membrane system comprising a semi-permeable or dense membrane for the filtration of aqueous liquid, which membrane contains an organic polymer and silver releasing particles as described in claim 1.

13. Process for the preparation of an antimicrobial filtration membrane, which process comprises inclusion of silver releasing particles as described in claim 1 into a polymer, and forming this polymer into a semipermeable or dense membrane.

14. Process according to claim 13 wherein the inclusion of the silver releasing particles into the membrane is carried out by precipitation moulding, melt casting or solution casting process.

15. A process for the treatment of aqueous liquids, in a membrane filtration system, which process comprises incorporation of silver releasing particles as described in claim 1 into the membrane.

16. the process according to claim 15, wherein the treatment of aqueous liquids is a water-treatment process comprising the filtration of an aqueous liquid or dispersion selected from food, beverages, pharmaceuticals and pre-products thereof, the separation of bio-molecules or bio-particles from aqueous liquids or dispersions in biotechnology or medicine, the filtration of water used in power generation, and/or the purification and/or decontamination of water for industrial processes, chemical processes, metal treatment, semiconductor processing, pulp and paper processing.

17. The membrane system according to claim 11, wherein the elemental silver has a specific surface area is 3 m²/g or more, such as silver nanoparticles of mean particle diameter 5-100 nm, or microsilver of porosity 50% or more.
